(19) United States
(12) Patent Application Publication
(10) Pub. No.: US 2017/0162838 A1
(43) Pub. Date: Jun. 8, 2017

(54) LEAKTIGHT FEEDTHROUGH OF GLASS-METAL TYPE, ITS USE FOR AN ELECTROCHEMICAL LITHIUM BATTERY, AND ASSOCIATED METHOD OF PRODUCTION

(71) Applicant: COMMISSARIAT A L'ENERGIE ATOMIQUE ET AUX ENERGIES ALTERNATIVES, Paris (FR)

(72) Inventors: Pascal REVIRAND, SAINT-EGREVE (FR); Lionel PICARD, SEYSSINET-PARISET (FR)

(73) Assignee: COMMISSARIAT A L'ENERGIE ATOMIQUE ET AUX ENERGIES ALTERNATIVES, Paris (FR)

(21) Appl. No.: 15/370,438

(22) Filed: Dec. 6, 2016

(30) Foreign Application Priority Data
Dec. 7, 2015 (FR) 15 61919

(51) Int. Cl. H01M 2/06; H01M 2/04; H01M 10/0525

(52) U.S. Cl. CPC H01M 2/065; H01M 10/0525; H01M 2/0478

(57) ABSTRACT

A method for making a feedthrough comprises
a/positioning of a body comprising a metallic wall with an orifice passing straight through it on a tool base, preferably one made of graphite;
   b/placing of the outer portion of the tool around the body;
   c/insertion of one or more metallic pins in the orifice emerging from the wall and then filling the rest of the orifice with a frit of electrically insulating material;
   d/placing the upper portion of the tool forming a piston against a zone including the orifice filled with the frit of electrically insulating material, preferably a glass frit, and in which the one or more pins is (are) inserted ;
   e/application of a temperature and pressure cycle, and a displacement of the piston, to carry out a flash sintering process.

### TECHNICAL FIELD

The present invention concerns a leaktight feedthrough of glass-metal type.

More particularly, the invention deals with a glass-metal feedthrough forming a terminal for an electrochemical lithium battery, such as a lithium-ion battery.

The invention proposes in the first place to improve the electrical insulation and leaktight characteristics while ensuring a good electrical conduction on either side of the feedthrough.

By “feedthrough” is meant the usual technological sense, that is, a device serving to pass an electrical conductor element through a wall and insulating the conductor from this wall.

Although specified in regard to its advantageous application as a terminal of a lithium battery, the invention can be implemented in any application requiring a leaktight feedthrough.

### Introduction

As illustrated schematically in FIGS. 1 and 2, a lithium-ion battery normally has at least one electrochemical cell C composed of an electrolyte 1 between a positive electrode or cathode 2 and a negative electrode or anode 3, a current collector 4 connected to the cathode 2, a current collector 5 connected to the anode 3, and finally a package 6 designed to contain the electrochemical cell with leak leak tightness while being traversed by a portion of the current collectors 4, 5.

The architecture of conventional lithium-ion batteries is an architecture which can be described as monopolar, since they have a single electrochemical cell comprising an anode, a cathode and an electrolyte. Several type of monopolar architecture geometry are known:
a cylindrical geometry, such as that disclosed in patent application US 2006/0121348,
a prismatic geometry such as that disclosed in patents U.S. Pat. No. 7,348,098, U.S. Pat. No. 7,338,733;
a stacked geometry such as is disclosed in the patent applications US 2008/060189, US 2008/0057392, and U.S. Pat. No. 7,335,448.

The electrolyte 1 can be of solid, liquid, or gel form. In the latter form, it may comprise a separator of polymer, ceramic, or microporous composite type, impregnated with organic electrolyte(s), or of ionic liquid type which enables the movement of the lithium ion from the cathode to the anode for a charging and conversely for a discharging, thus generating the current. The electrolyte is generally a mixture of organic solvents, such as carbonates, in which a lithium salt is added, typically LiPF₆.

The positive electrode or cathode 2 is composed of lithium cation insertion materials which are generally a composite, such as LiFePO₄, LiCoO₂, LiNi_{0.33}Mn_{0.33}Co_{0.33}O₂.

The negative electrode or anode 3 is very often composed of carbon graphite or Li₄TiO₅O₁₂ (titanate material), optionally also based on silicon or a silicon-based composite.

The current collector 4 connected to the positive electrode is generally made of aluminium.

The current collector 5 connected to the negative electrode is generally made of copper, nickeled copper, or aluminium.

A lithium-ion battery can of course comprise a plurality of electrochemical cells which are stacked one on another.

Traditionally, a Li-ion battery uses a pair of materials at the anode and at the cathode, allowing it to function at an elevated voltage level, typically equal to 3.6 Volts.

Depending on the type of application in view, one tries to realize either a thin and flexible lithium-ion battery or a rigid battery: the package is then flexible or rigid and in the latter case it constitutes a kind of housing.

The flexible packages are usually made from a multilayered composite material composed of a stack of aluminium layers covered by one or more polymer film(s) laminated by gluing.

As for the rigid packages, they are used when the applications in view are limiting and one wishes to have a long lifetime, with for example much higher pressures to be withstood and a more strict level of leak tightness required, typically less than 10⁻⁸ mbar·l/s, on in environments with strong constraints, such as aeronautics or space travel.

Thus, one rigid package used at present is composed of a metallic housing, generally made of a light and not very costly metal, typically stainless steel (grade 316L or 304) or aluminium (Al 1050 or Al 3003), or even titanium. Moreover, aluminium is generally preferred for its elevated thermal coefficient of conductivity, as explained below. Housings made of steel covered with a bimetallic coating of copper/nickel have already been considered in patent application WO 2010/113502.

Housings made of plastic material, especially those made entirely of polymer, have also been contemplated already, especially in patent application US 2010/316094. Although having a substantial mechanical strength, these housings have little chance of being economically feasible on account of the price of their component material.

Housings of mixed polymer/fibre material have also been contemplated.

Finally, one can mention housings integrated in supports which allow the Li-ion batteries to be recharged by a solar panel, such as a housing integrated in a helmet, as described in patent application CN 201690389 U.

The principal advantage of rigid packages is their elevated leak leak tightness which is maintained over time, thanks to the fact that the closure of the housings is accomplished by welding, generally laser welding. The major inconvenience of these rigid packages is their elevated weight, on account of the metal used for the housing.

The geometry of the majority of the rigid housings of Li-ion battery packages is cylindrical, since the majority of the electrochemical cells of the batteries are wound by winding in a cylindrical geometry. Prismatic forms of housings have also already been realized.

One of the types of rigid housing of cylindrical shape which is usually fabricated for a Li-ion battery of high capacity and a lifetime greater than 10 years is illustrated in FIG. 3.

The housing 6 comprises a lateral cylindrical envelope 7, a bottom 8 at one end, a lid 9 at the other end, the bottom 8 and the lid 9 being assembled on the envelope 7. The lid 9 supports the current output poles or terminals 40, 50. One of the output terminals (poles), for example the positive terminal 40, is welded to the lid 9, while the other output terminal, such as the negative terminal 50, passes through the lid 9 with the interpositioning of a seal, not shown, which electrically insulates the negative terminal 50 from the lid.

Whatever the type of package, flexible or rigid, for the housing which is considered at present, the electrochemical cell or cells is (are) in fact contained in a region which is completely leaktight to the outside.

Now, when the lithium battery is working, i.e., the electrochemical cell is under electrical voltage, heating occurs inside the latter. This is due to a lesser extent to the passage of currents toward the current connectors and mostly to the electrochemical reactions within each cell.

The dissipation of the heat of this heating is done naturally by the external walls of the electrochemical cell, i.e., those in contact with the package.

For this reason, the designers of lithium batteries, especially Li-ion batteries, systematically consider:
a. either battery housings of cylindrical shape with slight diameter and a ratio of height to diameter greater than 1;
b. or battery housings of prismatic shape with a larger wall surface as compared to those of cylindrical shape but still with a ratio of height to thickness greater than 1. Batteries of prismatic shape in fact have a higher energy density than those of cylindrical shape.

At present, two types of rigid housing are manufactured.

The first type likewise consists of a rigid housing with a deep-drawn cup and a lid welded together at their periphery by laser. On the other hand, the current collectors comprise a feedthrough with a projecting portion at the top of the housing and forming a terminal thus called the apparent pole of the battery.

A first example of the assembly of such a feedthrough 1 forming a terminal with the current collector 2 and with the lid 3 of a housing is shown in FIG. 4: the collector 2, typically made of copper in the shape of an internally threaded male part is fixed by screwing with the aid of a nut 2 of type M5 or M8. Two washers 5A, 5B made of electrical insulating material, typically polypropylene, placed one on top of the other, are inserted, one 5A between the lid 3 and the other washer 6 supporting the nut 4, and the other 5B between the lid 3 and the collector 2. These washers 5A, 5B produce the leak tightness and the electrical insulation of the collector 2 with respect to the lid 3 of the housing. More precisely, in this first example illustrated, the two insulating washers 5A, 5B are identical and each comprise a bearing portion 50A, 50B and a guiding and centring portion 51A, 51B. The bearing portion 50A is in surface bearing with a pressure against both the face 30 of the wall of the lid 3 and against the support washer 6 of the nut 4. In an analogous manner, the bearing portion 50B is in surface bearing against both the opposite face 31 of the lid 3 and against the bearing portion 20 of the current collector 2. The guiding and centring portions 51A, 51B, in turn, are in surface bearing with pressure against both the edge of the orifice 32 passing through the lid 2 and against the collector 2. These guiding and centring portions 51A, 51B make it possible to guide and centre both the washers 5A, 5B in the through orifice 32 and the male collector 2 in said washers 5A, 5B.

A second example of the assembly of a feedthrough 1 forming a terminal with the current collector 2 and with the lid 3 of a housing is shown in FIG. 5: the collector 2, typically made of copper, in the form of an internally threaded male part is secured by crimping of the collector on the support washer 6. Here as well, one finds the two washers 5A, 5B made of electrical insulating material, with their support portions 50A, SOB and their guiding and centring portions 51A, 51B which are arranged identically and perform the same functions as in the first example. On the other hand, the fixation by crimping according to this second example is done without the use of a supplemental part, such as the screwing nut 4 of the first example. In fact, the crimping is done by mechanical crushing of a crimping portion 21 disposed on the outside of the cylindrical part of the collector 2, against the support washer 6.

A third example of the assembly of a feedthrough forming a terminal with the current collector and with the lid of a housing is described in patent application FR 2798227.

In this first type of feedthroughs, many polymer materials can be used to provide the functions of electrical insulation and leak tightness. For example, one may refer to the publication [1], especially pages 1 to 168, for the electrical insulation functions and to pages 543 to 571 for the leak tightness functions.

However, the permeation with respect to water of the polymer materials classically used is very clearly greater than metallic material, especially the aluminium making up the housing of an electrochemical battery. This weakness of polymers may be detrimental to the behaviour and the lifetime of the electrochemical cell(s) of the battery.

The second type consists of a rigid housing composed of a machined bottom and a lid, welded together at their periphery by laser. The current collectors are formed in part by metallic wires or pins. The pin or pins is (are) welded by electric welding or by ultrasound to the portion of the corresponding current collector which is itself connected to one of the electrodes of an electrochemical cell or a stack of electrochemical cells. In order to produce the electrical insulation between the metallic lid of the housing and the metallic pin, a glass bead glazes the pin thus forming what is commonly called a glass-metal feedthrough (GMF). Moreover, to achieve the leak tightness with the lid of the housing, a collar around the glass bead and generally made of the same metal as that of the housing is welded to the latter. Certain configurations call for using a single GMF, the housing forming the other terminal, also known as the battery pole. This type of feedthrough for different batteries is widely described in the literature. One can cite, for example, the following patent applications or patents: EP1444741A1, U.S. Pat. No. 5,821,011A, U.S. at. No. 6,759,163B2, U.S. Pat. No. 7,687,200B2 which describe GMFs specific to Li-ion batteries.

There is represented in FIG. 6 a GMF of a Li-ion battery as is described in the patent U.S. Pat. No. 7,687,200B2: the lid 3 of the battery housing is pierced by an orifice, not shown, which is blocked by a glass seal 5 which is glazed about a metallic pin 2 crossing straight through the lid 3 and thus the housing. This GMF feedthrough allows for an insulating of the two terminals of the battery, one generally of positive polarity being provided by the metallic housing and the other generally of negative polarity provided by the insulated metallic pin 2 of the lid 3 and thus of the housing.

These GMF feedthroughs can be used in applications other than Li-ion batteries.

Moreover, other insulating feedthroughs are known in which the glass can be replaced by a ceramic, as is described in the patent application FR 2556123.

Glass has the advantage of having better characteristics of permeation with respect to water than polymer materials and a good thermal compatibility with the metals which may be used to form a battery housing, particularly aluminium.

The GMF feedthroughs are thus, as compared to the feedthroughs of the first aforementioned type with polymer washers, feedthroughs which can guarantee a better electrical insulation and a better leak tightness, while still assuring a good electrical conduction from one side to the other of the battery housing.

There is a need for improvement of the glass-metal feedthroughs, particularly in view of their application as a terminal for an electrochemical lithium-ion battery.

The purpose of the invention is to meet this need in part.

### SUMMARY

To accomplish this, the invention concerns, in one of its aspects, a feedthrough realized by an orifice emerging on either side of a metal wall, comprising one or more metal-based pins passing through a seal based on electrically insulating sintered material blocking the orifice, the seal based on sintered insulating material being realized by a flash sintering method.

Preferably, the electrically insulating material is a sintered glass.

In fact, all electrically insulating materials which can be sintered by a flash sintering method are suitable for making a feedthrough according to the invention. It is enough for the insulating material to have a melting point relatively close to the flash sintering temperature and for the latter to be compatible with the various other materials, those of the pins and the metallic wall, in particular.

In the principal application contemplated, the inventors started with an aluminium battery housing lid, and thus all the insulating materials able to be shaped at a temperature lower than the melting temperature of aluminium are suitable for the application. In particular, glass frit is perfectly suitable.

In other words, the invention consists in applying a flash sintering process to a frit of electrically insulating material, preferably a glass frit, in order for it to constitute the electrical insulation and leak tightness seal of a feedthrough.

The glass frit according to this process has a very good thermal compatibility with aluminium, which is the material making up the housings of the lithium battery.

The feedthrough obtained according to the invention constitutes a leaktight passage, which thanks to the metallic pin(s) enables an electrical conduction from one side to the other of the passage, and which presents an electrical insulation and a leak tightness thanks to the sintered glass seal.

By “flash sintering process” is meant the usual technological sense, as is detailed in the publication [2]. The flash sintering process is commonly called “Spark Plasma Sintering” (SPS), or also “Field Assisted Sintering Technique”, or also “Pulsed Electric Current Sintering” (PECS).

Flash sintering is a sintering process derived from traditional hot pressing. Consequently, the installations for implementing a flash sintering also include a water cooled compartment, a hydraulic press system, and a command and control unit which controls the temperature, the compression force, and the vacuum or gaseous atmosphere inside the compartment.

The principal difference in relation to the traditional hot presses lies in the fact that the flash sintering is done without a heating resistance or traditional thermal insulation of the compartment. Instead, the punch of the press is equipped with a special heavy-current feed and a water cooling, to act as an electrode and to send the current directly through the mould and the powder which it contains. This special structure makes it possible to obtain a homogeneous heating of the mould and the powder which it contains by the Joule effect. Thus, even at elevated heating rate, one obtains relatively slight temperature gradients, whereas traditional sintering encounters limits due to temperature gradients and only allows the use of medium heating rates, which in turn result in longer holding time during the subsequent homogenization (which is therefore often incomplete).

Another advantage of the flash sintering process is that the thermal power which is furnished is not only distributed in a homogeneous manner on the macroscopic scale over the volume of powder being pressed, but it is also transmitted, on the microscopic scale, precisely to the points for which energy is needed in the sintering process, namely, the points of contact between the powder particles. Hence, the flash sintering is of better quality with a slight growth of the grains.

Likewise, this process largely eliminates the unwanted processes of decomposition or reaction, making it possible to obtain a transition structure heretofore considered to be impossible. Depending on the type of powder (frit), some researchers report other positive effects at the points of contact, such as electromigration or production of microplasma.

A seal based on glass sintered by an SPS process not only assures the different desired functions (passage of current, leak tightness), but also thanks to eliminating the transition of the glass frit to the molten state, it is able to obtain complex geometries directly at the sides. Moreover, this also allows for increased complexity of the passages, enabling the producing of outputs with several terminals.

Preferably, a metal sheet is welded to at least one end of a pin, the welded sheet forming part of a current collector.

According to one advantageous variant, the sintered glass is based on alkaline oxides.

The pin or pins can advantageously be made of aluminium.

According to one advantageous embodiment, each pin forms a terminal of an electrochemical lithium battery of Li-ion type.

The invention also concerns in another of its aspects a lithium-ion (Li-ion) battery comprising a housing with a lid through which is realized a feedthrough, as described above.

The lid can be made of aluminium, such as aluminium 1050 or 3003, and the pin or pins are made of aluminium or nickel or copper.

The material of the negative electrode(s) can be chosen from the group including graphite, lithium, titanate oxide Li₄TiO₅O₁₂; the material of the positive electrode(s) can be chosen from the group including LiFePO₄, LiCoO₂, LiNi_{0.33}Mn_{0.33}Co_{0.33}O₂.

Finally, the invention concerns a method for making a feedthrough as described above, involving the following steps:

a/positioning of the body comprising the wall on a tool base, preferably one made of graphite;

b/placing of the outer portion of the tool around the body;

c/insertion of one or more metallic pins in the orifice emerging from the wall and then filling the rest of the orifice with a glass frit;

d/placing the upper portion of the tool forming a piston against a zone including the orifice filled with the frit of electrically insulating material, preferably a glass frit, and in which the one or more pins is (are) inserted ;

e/application of a temperature and pressure cycle, and a displacement of the piston, to carry out a flash sintering process.

Preferably, prior to step a/ and/or step d/, a sheet of carbon paper is placed respectively between the tool base and the body and/or between the body and the tooling piston. Each sheet of carbon paper allows the prevention of unwanted welds between the different components during the application of the flash sintering cycle. The current flows needed to carry out the flash process pass through each sheet of carbon paper so as to separate the glass portion from the metallic pins, after the densification of the glass frit.

Further preferably, prior to step a/ and/or step d/, a metallic sheet, preferably aluminium, is placed respectively in contact with the lower end of the pin or pins and/or with the upper end of the pin or pins. The insulating glass frit is attached to each metallic sheet.

Once the feedthrough is complete, each sheet makes it possible to accomplish the closure of the battery housing by an adapted welding means, such as TIG, laser, or electron beam welding.

### BRIEF DESCRIPTION OF DRAWINGS

Other advantages and characteristics of the invention will emerge more clearly upon perusal of the detailed description of exemplary embodiments of the invention given as an illustration and not a limitation, making reference to the following figures, in which:

FIG. 1 is a schematic perspective exploded view showing the different elements of a lithium-ion battery,

FIG. 2 is a front view showing a lithium-ion battery with its flexible package according to the prior art,

FIG. 3 is a perspective view of a lithium-ion battery according to the prior art with its rigid package comprised of a housing;

FIG. 4 is an axial section view of a feedthrough forming a terminal of an Li-ion battery according to one example of the prior art;

FIG. 5 is an axial section view of a feedthrough forming a terminal of an Li-ion battery according to another example of the prior art;

FIG. 6 is a perspective view of a feedthrough of glass-metal type forming a terminal of a Li-ion battery according to another example of the prior art;

FIG. 7 is an axial section view of a feedthrough, designed to form a terminal of a Li-ion battery according to one example of the invention;

FIG. 8 is an axial section view of a tooling in which the different components of a feedthrough according to the invention are housed, the tooling being adapted to carry out a flash sintering process;

FIG. 9 illustrates, in the form of temperature and pressure curves varying as a function of time, an example of a flash sintering cycle applied to the tooling shown in FIG. 8 in order to obtain the feedthrough according to the invention;

FIG. 10 illustrates schematically a representative stacking of elements of a feedthrough according to the invention on which tests were performed;

FIGS. 11A to 13B are reproductions of sectional views obtained by scanning electron microscope (SEM) at various magnifications of a stack illustrated schematically in FIG. 10 having undergone the application of a flash sintering cycle, at different temperatures.

### DESCRIPTION OF EXEMPLARY EMBODIMENTS

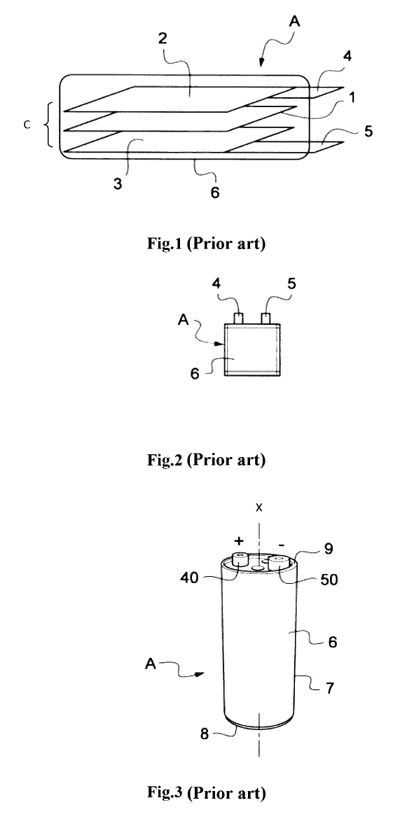

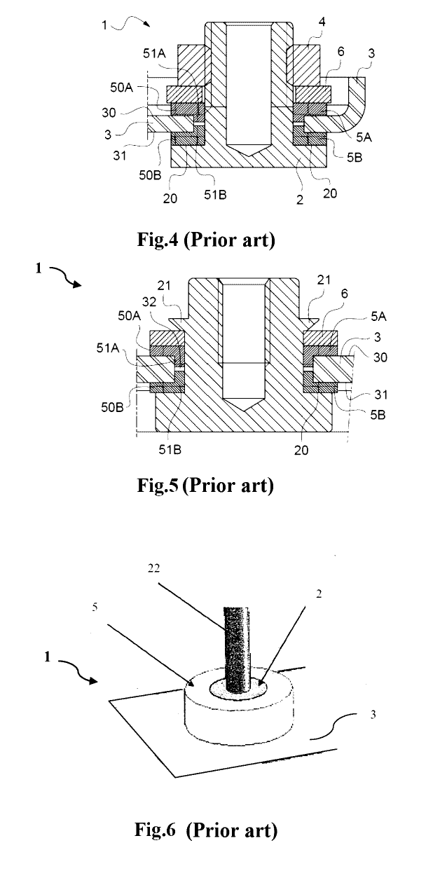

FIGS. 1 to 6 pertain to different examples of Li-ion battery, housings and feedthroughs forming terminals of the Li-ion battery according to the prior art. These FIGS. 1 to 6 have already been commented upon at the outset and thus will not be further discussed here.

For reasons of clarity, these same references designating the same elements of feedthroughs according to the prior art and according to the invention are used for all FIGS. 1 to 6.

Throughout the present application, the terms “lower”, “upper”, “bottom”, “top”, “below” and “above” are to be understood with regard to a housing of a Li-ion battery positioned vertically with its lid on top and the feedthrough exiting to the outside of the housing on top.

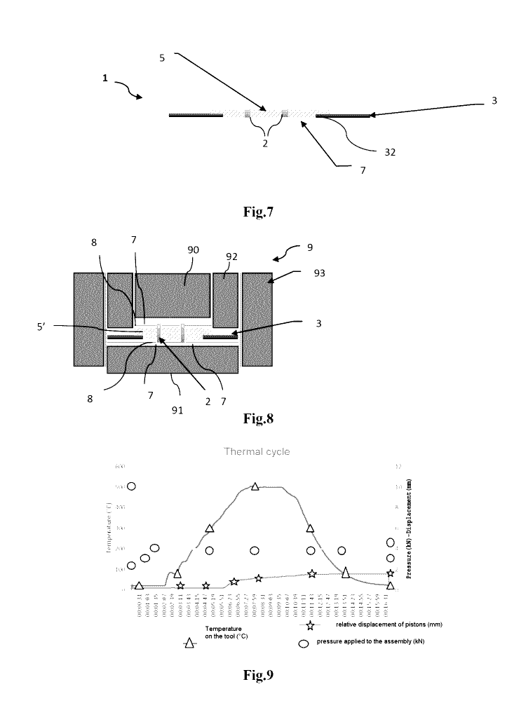

There is shown in FIG. 7 an example of a feedthrough forming the terminal 1 of a Li-ion battery according to the invention.

The feedthrough 1 according to the invention is realized through an orifice not emerging from both sides of a lid 3 of a Li-ion battery housing.

The feedthrough 1 represented comprises two pins 2, preferably of aluminium, passing through the orifice 32 and fixed to its inside by means of a seal of insulating glass frit 5, obtained by application of a flash sintering process.

Moreover, at each end of a pin there is secured a metal sheet 7 making it possible to close the battery housing by an adapted welding means, such as TIG, laser, electron beam welding. More precisely, the lower metal sheet 7, that is, the one designed to appear on the inside of the battery housing and designed to be welded to the current collector of one or the other of the electrodes of the electrochemical cell making up the battery.

To realize the feedthrough 1 according to the invention, one can use a graphite tooling 9 such as is shown schematically in FIG. 8. This tooling 9 is adapted to implement a flash sintering process.

The tooling 9 comprises an upper part forming a press piston 90, a lower part forming a base 91, the piston 90 being able to move relatively between outer peripheral walls 92, 93. The peripheral walls 92 make it possible to bound off a space inside which the glass frit is confined, while the outermost peripheral walls 93 determine the space for positioning of the lid 3.

The method according to the invention comprises the following steps:

Step a/: the lid 3 is positioned on the base 91 of the tooling. Prior to this, a carbon sheet 8 is inserted between the base 91 and the lid 3, in order to prevent any detrimental welding in the course of the process. Also prior to this, a metallic sheet of aluminium 7 is inserted, being in contact with each lower end of the pin 2.

Step b/: the outer portion 92, 93 of the tooling is put in place around the lid 3.

Step c/: the metal pins 2 are inserted, while holding them, into the orifice 32 emerging from the wall of the lid. The rest of the orifice is then filled with glass frit 5′.

As an example, the glass frit 5′ used can be that sold under the brand GL57 by the Ferro company. The chemical elements making up this glass frit with their percentage by weight are as follows:
oxygen: 43.30%
carbon: 7.51%
silicon: 16.01%
aluminium: 0.27%
sodium: 12.09%
titanium: 12.11%
phosphorus: 1.06%
potassium: 7.64%.

Step d/: the piston 90 of the tooling is then put in place against a zone comprising the orifice 32 filled with glass frit 5′ and in which the pins 2 have been inserted and supported. Prior to this, as for step a/, a carbon sheet 8 is inserted between the lid 3 and the piston 90 and a metallic sheet made of aluminium 7 is inserted, being in contact with each upper end of the pin 2.

Step e/: a temperature and pressure cycle and a displacement of the piston 90 is done to carry out a flash sintering process.

One advantageous example of a cycle as a function of time is illustrated by the curves in FIG. 9.

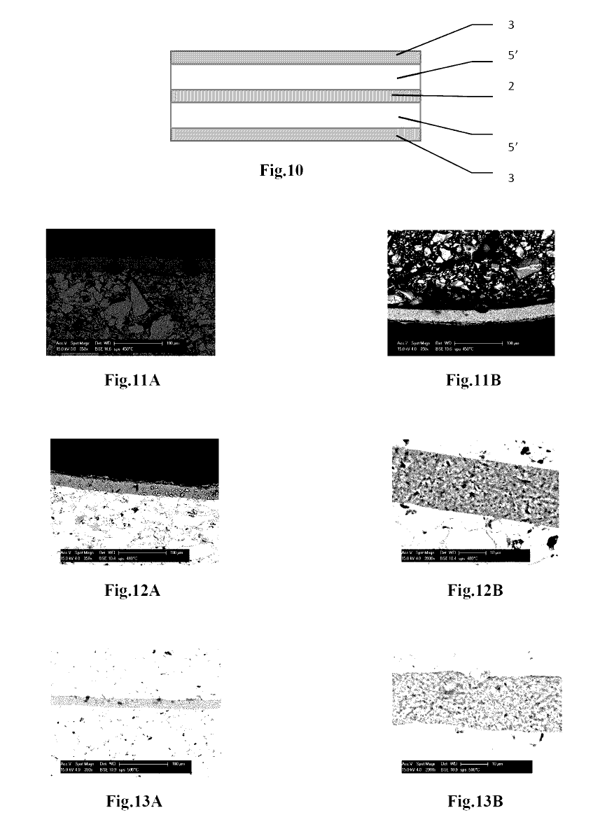

The inventors have performed various tests of an alternating stack of glass frit 5′ and aluminium pins 2 as shown in FIG. 10, with the aid of the tooling 9 and according to different flash sintering cycles.

FIGS. 11A and 11B show in cross section the densification of the substrate obtained at a temperature of 450° C., respectively, under the same magnification of 350×, but with different contrast adjustment.

FIGS. 12A and 12B show in cross section the densification of the substrate obtained at a temperature of 480° C., respectively, under a magnification of 350× and 2000×.

FIGS. 13A and 13B show in cross section the densification of the substrate obtained at a temperature of 500° C., respectively, under a magnification of 350× and 2000×.

It emerges from these SEM views that there is a better densification of the glass and a better cohesion/contact between the aluminium and the glass frit at 500° C. as compared to 480° C. and 450° C.

The feedthrough 1 according to the invention can be realized on a lid 3 of a Li-ion battery housing both in a cylindrical geometry and in a prismatic geometry. In these different configurations, the terminal 1 according to the invention is negative, for example, while the positive terminal can be realized directly by welding, for example, also on the lid 3.

The invention is not limited to the examples just described; in particular, characteristics of the examples illustrated can be combined in the context of variants not illustrated.

Other variants and improvements can be contemplated without thereby leaving the scope of the invention.

While in the embodiments illustrated the material of the seal is a glass frit, any electrical insulating material will be suitable, as long as it is relatively close to the melting point, and the temperature of the flash sintering process is compatible with the various other materials, particularly the aluminium of the pins and of the lid.

Thus, for any suitable electrically insulating material, one must make sure that the temperature of the flash sintering process is slightly less than the melting temperature.

In the embodiment illustrated in FIGS. 7 and 8, the feedthrough comprises two pins 2 each constituting a terminal of the battery. It is quite possible to realize a leaktight passage with only a single terminal and to use the housing of the battery as a second terminal. More generally, one can contemplate leaktight feedthroughs according to the invention integrating a number of conductor pins equal to one, two, three, four, and so on.

What is claimed is:

1. A method for making a feedthrough comprising the following steps:
a/positioning of a body comprising a metallic wall with an orifice passing straight through it on a tool base;
b/placing of the outer portion of the tool around the body;
c/inserting one or more metallic pins in the orifice emerging from the wall and then filling the rest of the orifice with a frit of electrically insulating material;
d/placing the upper portion of the tool forming a piston against a zone including the orifice filled with the frit of electrically insulating material and in which the or each pin is inserted;
e/application of a temperature and pressure cycle, and a displacement of the piston, to carry out a flash sintering process.

2. The method according to claim 1, whereby prior to step a/ and/or step d/ a sheet of carbon paper is placed respectively between the tool base and the body and/or between the body and the tooling piston.

3. The method according to claim 1, whereby prior to step a/ and/or step d/ a metallic sheet is placed respectively in contact with the lower end of the pin or pins and/or with the upper end of the pin or pins.

4. The method according to claim 1, wherein a metallic sheet is welded to at least one end of a pin, the welded sheet forming part of a current collector.

5. The method according to claim 1, wherein the sintered electrically insulating material of the seal is a sintered glass.

6. The method according to claim 5, wherein the sintered glass is based on alkaline oxides.

7. The method according to claim 1, wherein the pin or each pins is made of aluminium.

8. The method according to claim 1, wherein the tool base is made of graphite.

9. The method according to claim 1, wherein the frit is a glass frit

10. A lithium-ion (Li-ion) battery comprising a housing with a lid through which is realized a feedthrough obtained according to the method of claim 1.

11. The lithium-ion battery according to claim 10, wherein the lid is made of aluminium and wherein the or each pin or pins is made of aluminium or nickel or copper.

12. The lithium-ion battery according to claim 11, wherein the lid is made of aluminium 1050 or 3003.

13. The lithium-ion battery according to one of claims 10, wherein:
the material of one or more negative electrodes of the battery is chosen from the group including graphite, lithium, titanate oxide Li₄TiO₅O₁₂; and
the material of one or more positive electrodes of the battery is chosen from the group including LiFePO₄, LiCoO₂, LiNi_{0.33}Mn_{0.33}Co_{0.33}O₂.
